(19) United States
(12) Patent Application Publication
(10) Pub. No.: US 2018/0211520 A1
(43) Pub. Date: Jul. 26, 2018

(54) DISTRIBUTION OF TRAFFIC INFORMATION

(71) Applicant: Robert Bosch GmbH, Stuttgart (DE)

(72) Inventors: Andreas Offenhaeuser, Marbach Am Neckar (DE); Erik Lesser, Steinheim (DE); Martin Kieren, Marbach A. N. (DE); Nils Hagenlocher, Stuttgart (DE)

(21) Appl. No.: 15/746,734

(22) PCT Filed: Jun. 2, 2016
(86) PCT No.: PCT/EP2016/062561

§ 371 Date: Jan. 22, 2018

(30) Foreign Application Priority Data
Jul. 31, 2015 (DE) 10 2015 214 575.1

(51) Int. Cl. G08G 1/01; B60W 40/04; G08G 1/16

(52) U.S. Cl. CPC G08G 1/0112; B60W 30/02; G08G 1/161; B60W 40/04

(57) ABSTRACT

A method for distributing traffic information includes acquiring status information in a first vehicle, the status information pertaining to a physical state of the surroundings and/or of the first vehicle; acquiring position information in the first vehicle which encodes a position of the first vehicle at which the status information was determined; transmitting the status information and the position information to a central internet server; storing the status information in an electronic map in the central internet server based on the position information;

transmitting status information from the electronic map to a second vehicle if the second vehicle moves toward a position that is encoded by position information and for which the status information is stored in the electronic map; and activating an assist system in the second vehicle which is designed to warn and/or to assist a driver of the second vehicle with regard to the physical state.

### FIELD

The present invention relates to a method for distributing traffic information.

### BACKGROUND INFORMATION

In many vehicles, assist systems or functions, such as a crosswind assist (CWA), for example, an anti-snaking assist for trailers (trailer sway mitigation—TSM) or detection of loose wheel lug bolts, are implemented in order to make driving safer and more comfortable.

These assist systems or functions are also able to perform certain actions within the vehicle. For instance, upon detection of a snaking trailer, an anti-snaking assist is able to brake the towing vehicle in such a way that the vehicle train is stabilized. On the whole, it may be advantageous if the vehicle also handles critical situations independently, without the assistance of the driver. For example, the vehicle could preventively avoid critical situations.

German Patent No. 10 2008 043 743 A1 describes a method in which data are acquired about an object in the area surrounding a vehicle, and the data about the state of the object may then be transmitted to a highway maintenance department, for example.

### SUMMARY

Specific embodiments of the present invention advantageously make it possible to automatically transmit important information between vehicles, and thus to make road traffic safer.

The present invention relates to a method for distributing traffic information. In particular, the traffic information may be exchanged via a central internet server between a multitude of vehicles such as automobiles, trucks, buses and motorcycles, for instance. It is to be understood that traffic information of any kind may pertain to information which is relevant for road traffic.

According to one specific embodiment of the present invention, the method includes: Acquiring status information in a first vehicle, the status information pertaining to a physical state of the surroundings and/or of the first vehicle; acquiring position information of the first vehicle in the first vehicle, the position information encoding a position of the first vehicle at which the status information was determined; and transmitting the status information and the position information to a central internet server. These functions may be carried out by a control unit in the first vehicle. For example, the on-board computer or an ESP assist (vehicle dynamics control, electronic stability program) contained in it collects status information about crosswind, rolling motions, friction behavior of the wheels on the road, etc. This information is augmented with position information from a GPS system, for instance, and transmitted via a mobile data connection to the central internet server. Consequently, position information may include GPS coordinates.

The status information may include information about crosswind, ruts, aquaplaning, trailer snaking or loose wheel lug bolts, coefficients of friction of the road. It may also include sharp deceleration, emergency-braking functions (automated emergency brake—AEB) or avoidance of follow-on collisions.

In addition, the method includes: Storing the status information in an electronic map in the central internet server based on the position information. The central internet server collects the status information and stores it, referenced with regard to the specific position information, in a database. This database may be an electronic map. The central internet server may be a single computer, a multicomputer system or a cloud computing device. The central internet server may be a distributed system which provides a central interface for the vehicles.

Further vehicles (and the first vehicle, as well) are able to retrieve the information stored in the electronic map. For example, they may report their present position to the central internet server, which then sends them the status information together with the position information that lies ahead of the vehicle in question on a section of the route which the vehicle is following.

Furthermore, the method includes: Transmitting status information from the electronic map to a second vehicle if the second vehicle moves toward a position that is encoded by position information and for which the status information is stored in the electronic map; and activation of an assist system (i.e., an actuator) in the second vehicle which is designed to warn and/or to assist a driver of the second vehicle with regard to the physical state. Consequently, the second vehicle receives status information about the surroundings it will (soon) be passing through and/or of other vehicles driving ahead of the vehicle.

The status information and the position information may be received and the pertinent assist systems may be activated by a control unit of the second vehicle. This control unit is also able to transmit the status information and position information, as described above. For example, if a preceding first vehicle begins to snake, the driver of a following second vehicle may be informed about it with the aid of steering-wheel vibrations, a warning tone and/or a warning light. For instance, the second vehicle may also be braked automatically if it is approaching a pothole that other first vehicles have already identified.

The first vehicle, the central server and the second vehicle may be networked via the internet. The first vehicle and the second vehicle may be connected to the central internet server via a mobile internet connection, and may transmit the status information and the position information via the internet connection. All in all, vehicles networked in this way are better able to predict events and conditions, and therefore are also better able to avoid them. This may bring with it a marked improvement in driving comfort and driving safety.

According to one specific embodiment of the present invention, a plurality of first vehicles acquire status information and transmit it together with position information to the central internet server. In this way, an electronic map may be set up, by the fact that a plurality of vehicles transmit their, e.g., geocoded information to a central internet server.

In the internet server, the status information may be aggregated based on its position information and checked for plausibility. The new information thus obtained may now be made available to other users (i.e., further vehicles) and/or services (such as an internet map service or an agency, for instance).

According to one specific embodiment of the present invention, the central internet server compares to each other status information which is recorded at the same position in the electronic map, in order to check the status information for plausibility and/or to aggregate it. For example, status information of the same type (like ruts, for instance) may first be marked as verified in the electronic map when it has been reported by several vehicles. Status information of the same type (like coefficients of friction of a road, for instance) which comes from several vehicles may also be averaged.

It is to be understood that status information may have the same position if its position information encodes positions which are less than a minimum distance away from each other.

Is also possible for the central internet server to determine certain positions or road sections at which specific status information is recorded particularly frequently. For example, especially windy road sections or particularly dangerous road sections where, e.g., strong braking operations were frequently recorded, may be identified. In this way, the central internet server is able to engage in data mining in the electronic map.

According to one specific embodiment of the present invention, the central internet server compares status information at one position in the electronic map to supplementary information which is provided by a further internet server, in order to check the status information for plausibility. For instance, status information about crosswind may be checked for plausibility using data from a weather service. Status information about a traffic jam (which, e.g., was determined owing to the stop-and-go behavior of the first vehicle) may also be compared with the data of a further map service.

According to one specific embodiment of the present invention, the central internet server augments status information with supplementary information from a further internet server and transmits the supplementary information to the second vehicle, as well. For example, status information about crosswind may be augmented with the wind velocity and/or the wind direction. It is also possible to add the length of a traffic jam to the traffic-jam information, for instance.

According to one specific embodiment of the present invention, in addition, time information is transmitted to the central internet server, the time information encoding when the status information was acquired. In the case of temporary events like crosswind or snaking, the electronic map may then be updated accordingly and/or the status information in the electronic map may also be erased again if it is no longer current.

According to one specific embodiment of the present invention, control parameters for assist systems are adapted in the second vehicle based on the status information transmitted to the second vehicle. For instance, in response to a danger of skidding (low coefficients of friction), various assist systems such as ESP or a distance-keeping system may be set to be more sensitive.

According to one specific embodiment of the present invention, the status information pertains to physical properties appearing temporarily in the environment. This may be visibility, temperature, wind or precipitation, for instance. After a predetermined time has elapsed since the status information was acquired and/or entered into the electronic map, it may be erased from the electronic map.

According to one specific embodiment of the present invention, the status information relates to road properties attached to one locality. Status information may also include properties of the road such as coefficients of friction, aquaplaning, potholes, ruts, etc.

According to one specific embodiment of the present invention, the status information relates to an operating behavior of the first vehicle. This may be snaking or sharp braking, for example.

According to one specific embodiment of the present invention, a position of status information which relates to an operating behavior of the first vehicle is updated in the electronic map based on a velocity and/or a present position of the first vehicle. For example, the position of the snaking vehicle may be transmitted, updated based on its movement data, to a following vehicle.

According to one specific embodiment of the present invention, the status information is calculated from sensor data of sensors located in the first vehicle. The first vehicle may be used as sensor, so to speak, in order to determine crosswind, ruts, aquaplaning, trailer snaking or loose wheel lug bolts as status information. For example, algorithms and sensors already available in the ESP may be used for this purpose.

Ideas with respect to specific embodiments of the present invention may also be regarded, inter alia, as based on the thoughts and findings described in the following.

### BRIEF DESCRIPTION OF THE DRAWINGS

Specific embodiments of the present invention are described hereinafter with reference to the figures, neither the figures nor the description herein to be interpreted as restrictive of the present invention.

FIG. 1 shows schematically a system for distributing traffic information according to one specific embodiment of the present invention;

FIG. 2 shows a flow chart that illustrates a method for distributing traffic information.

The figures are merely schematic and not true to scale. Identical reference numerals denote features that are identical or exercise generally similar effects in the figures.

### DETAILED DESCRIPTION OF EXAMPLE EMBODIMENTS

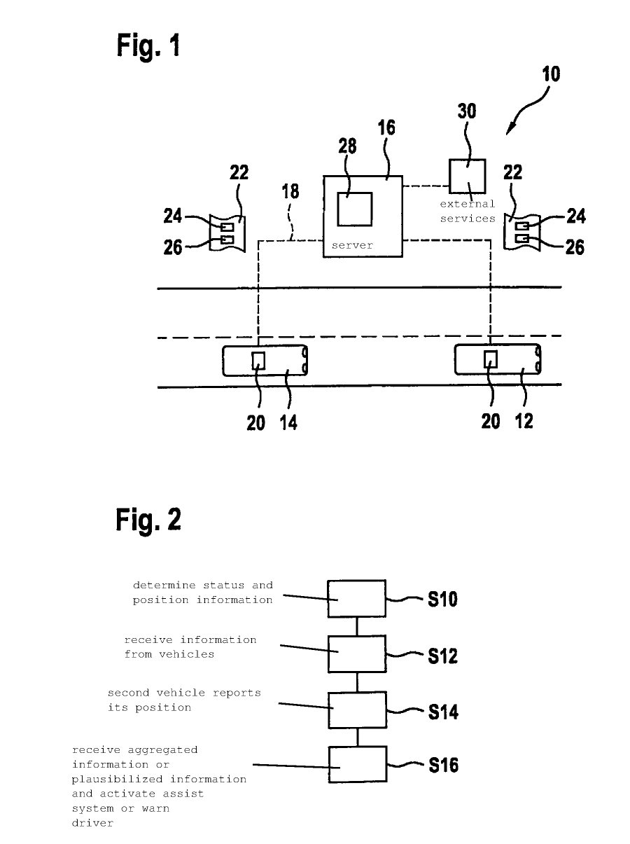

FIG. 1 shows a system 10 made up of a first vehicle 12, a second vehicle 14 and a central internet server 16, which are connected via the internet. Vehicles 12, 14 are each able to exchange data or information with server 16 via a mobile data connection 18.

Both vehicles include a control unit 20, e.g., an on-board computer, that is able to exchange data packets 22 having information about vehicles 12, 14 with central server 16. These data packets 22 may contain status information 24 about vehicles 12, 14 and/or their surroundings as well as position information 26 of vehicles 12, 14.

For example, status information 24 may include crosswind, ruts in the road, potholes in the road, snaking of the vehicle, aquaplaning, a sharp braking operation, the triggering of the ABS, etc.

Position information 26 may include GPS coordinates, which come from a GPS receiver in vehicles 12, 14.

Central internet server 16, which may be provided by a cloud computing device, for example, generates an electronic map 28 from received data packets 22. For instance, this may be a database, in which the status information 24 is filed and stored together with associated position information 26.

In addition, internet server 16 may be connected via the internet to other services or servers 30, such as a weather service or the computer of an agency, for instance.

FIG. 2 shows a flow chart that illustrates a method which may be implemented by the system from FIG. 1.

In step S10, sensors of first vehicle 12, such as rotational-speed sensors at the wheels, acceleration sensors and/or position sensors of the vehicle or perhaps an external-temperature sensor, acquire sensor information, which is then evaluated by control unit 20 to form status information 24. For example, an ABS assist is able to determine coefficients of friction of the road or aquaplaning events and/or an STM assist may determine a snaking event of the first vehicle.

In addition, first vehicle 12, i.e., control unit 20, determines the position of first vehicle 12 (e.g., with the aid of GPS), and from that, generates position information 26.

Status information 24 and position information 26 is then transmitted via mobile data connection 18 to server 16.

In step S12, server 16 receives information 24, 26 from various vehicles 12, 14 and enters it into electronic map 28. Status information 24 at specific positions may be aggregated by server 16 and checked for plausibility. For example, this may be accomplished with the aid of external services 30 such as a weather service, for instance, older vehicle information, an online roadmap, data from road operators, etc.

Server 16 subsequently makes aggregated information 22 available to vehicles 12, 14 again. In addition, supplementary information may be generated which likewise may then be made available. For example, the crosswind intervention may be supplemented by the wind direction.

In step S14, second vehicle 14 reports its position (e.g., via position information 26) to server 16, and it sends vehicle 14 status information 24 which is stored in electronic map 28 and is assigned to positions that vehicle 14 is approaching. For example, this may be a 10m-15m portion of the route which vehicle 14 will cover during the next minute.

Vehicle 14 receives information 24, 26, aggregated and/or checked for plausibility, for example, and then (in step S16) activates an assist system or an actuator which warns (visually, acoustically and/or haptically) the driver about an event which status information 24 predicts. It is also possible for the assist system or the actuator to intervene directly in the operating behavior of vehicle 14, for example, by braking vehicle 14.

For instance, the parameters for a vehicle motion control may be adapted in keeping with received information 24, 26.

In addition, the activation thresholds, parameters, precontrols for assistance functions or safety functions may be adapted with a necessary foresight based on received information 24, 26.

Moreover, information 24, 26 may also be used to compensate for sensor inadequacies. Furthermore, supplementary information from server 16 may be used to validate the activation conditions. For example, if it is known that several vehicles 12, 14 have experienced an intervention by a crosswind assist at a specific location, the probability is very high that other vehicles 12, 14 will also have an intervention at this location. For instance, if crosswind interventions are reported by many vehicles 12, 14 at the same position, and at the same time, wind gusts are reported by a weather service 30, this information may be classified as plausible. Due to the additional weather-service information, the wind direction is known and may serve as supplementary information. This information may then be made available to other vehicles 12, 14. The reception of this information may then bring about a precontrol of the crosswind assist or adjust the activation thresholds for a CWA or activate or deactivate corresponding functions. In addition, a visual or haptic predictive warning may also be effected.

For example, if ruts are identified by several vehicles 12, 14, this information 24, 26 may be made available to a highway department, for instance. In addition, other vehicles 12, 14 may be informed predictably about ruts. Consequently, the CWA may also use information 24, 26 to validate a situation, for example. If a rut is interpreted falsely as crosswind, for instance, this could result in a false intervention by the CWA. If it is known, however, that there are ruts, an activation threshold for the CWA may be raised.

An anti-snaking-logic intervention may also be sent to server 16. This information 24, 26 is able to warn second vehicles 14 in the immediate vicinity behind first vehicle 12 of the anti-snaking-logic intervention recently carried out. This information 24, 26 is only of relatively brief relevance timewise, and after a short time window, may be erased from electronic map 28 again. The attentiveness of other road users may thereby be increased.

Finally, it should be pointed out that terms such as “having”, “including”, etc., do not rule out other elements or steps, and terms such as “one” or “a” do not exclude multiplicity. Reference numerals in the claims are not to be regarded as restricting.

1-10. (canceled)

11. A method for distributing traffic information, the method comprising:
acquiring status information in a first vehicle, the status information pertaining to a physical state of at least one of: (i) surroundings of the first vehicle, and (ii) the first vehicle;
acquiring position information in the first vehicle, the position information encoding a position of the first vehicle at which the status information was determined;
transmitting the status information and the position information to a central internet server;
storing the status information in an electronic map in the central internet server based on the position information;
transmitting status information from the electronic map to a second vehicle if the second vehicle moves toward a position that is encoded by position information and for which the status information is stored in the electronic map; and
activating an assist system in the second vehicle which is designed to at least one of warn a driver of the second vehicle with regard to the physical state, and assist a driver of the second vehicle with regard to the physical state.

12. The method as recited in claim 11, wherein a plurality of first vehicles acquire status information and transmit the status information together with position information to the central internet server, and the central internet server compares to each other status information which is recorded at the same position in the electronic map at least one of: (i) to check the status information for plausibility, and (ii) to aggregate the status information.

13. The method as recited in claim 11, wherein the central internet server compares status information at one position in the electronic map to supplementary information which is provided by a further internet server, to check the status information for plausibility.

14. The method as recited in claim 11, wherein the central internet server augments the status information with supplementary information from a further internet server and transmits the supplementary information to the second vehicle.

15. The method as recited in claim 11, wherein time information is also transmitted to the central internet server, the time information encoding when the status information was acquired.

16. The method as recited in claim 11, wherein control parameters for assist systems are adapted in the second vehicle based on the status information transmitted to the second vehicle.

17. The method as recited in claim 11, wherein at least one of: (i) the status information pertains to physical properties appearing temporarily in the environment, and (ii) after a predetermined time has elapsed since the status information was at least one of acquired and entered into the electronic map, the status information is erased from the electronic map.

18. The method as recited in claim 11, wherein the status information relates to road properties attached to one locality.

19. The method as recited in claim 11, wherein at least one of: (i) the status information relates to an operating behavior of the first vehicle, and (ii) a position of status information which relates to an operating behavior of the first vehicle is updated in the electronic map based on at least one of a velocity of the first vehicle and a present position of the first vehicle.

20. The method as recited in claim 11, wherein the status information is calculated from sensor data of sensors located in the first vehicle.
